(19) United States
(12) Patent Application Publication
(10) Pub. No.: US 2013/0283199 A1
(43) Pub. Date: Oct. 24, 2013

(54) Access to an Application Directly from a Lock Screen

(71) Applicants: Aaron Alexander Selig, Mill Valley, CA (US); Il Yeo, Bellevue, WA (US)

(72) Inventors: Aaron Alexander Selig, Mill Valley, CA (US); Il Yeo, Bellevue, WA (US)

(73) Assignee: MICROSOFT CORPORATION, Redmond, WA (US)

(21) Appl. No.: 13/454,754

(22) Filed: Apr. 24, 2012

(51) Int. Cl. G06F 3/048; G06F 3/041

(52) U.S. Cl. 715/781

(57) ABSTRACT

Systems, methods and computer program products for facilitating access to an application or action directly from a lock screen user interface while interacting with a (mobile) computing device are disclosed. Such systems, methods and computer program products provide a multi-stage approach—a first user input-based component (e.g., touch, swipe, voice commands) within a security user interface (e.g., lock screen user interface) followed by a second application or action-based component (e.g., action shortcut and/or action) launched directly from the security user interface. That is, to deactivate the lock screen user interface, the user provides an authorized user input at the computing device. Second, to access the application or action, an application or action shortcut user interface is automatically displayed or the application or action is automatically launched; both directly from the lock screen user interface without requiring any additional user interaction.

### FIELD OF THE INVENTION

The present disclosure generally relates to computer graphical user interfaces and more particularly to systems, methods and computer program products for providing access to an application or action directly from a lock screen user interface while interacting with a computing system.

### BACKGROUND

In today's technological environment, it is common for people to interact with their computing devices—such as mobile telephones, laptops, tablet computers, personal digital assistants (PDAs) and the like—in ways other than using a keyboard and mouse. One example is use of a touch screen or voice user interface to access various applications or actions of a mobile computing device. As such, unintentional access to such applications/actions can become troublesome. Various lock screen user interfaces exist to prevent unauthorized or unintentional access to the computing device. For example, mobile devices running the WINDOWS® Phone operating system (available from Microsoft, Corporation of Redmond, Wash.) enable a user to define a touch pattern gesture to unlock a lock screen. This feature, known as pattern unlock, enables a user to define a gesture to authenticate the user and unlock the mobile computing device. Once the computing device is unlocked, the user can execute any and all of the functionality of the computing device.

An exemplary user scenario can include the need to intermittingly execute note taking tasks of to-do-list items on the go. During extended time periods, the computing device may repeatedly lock due to intermittent user inactivity. Another user scenario may include selective access to the mobile computing device's telephone, email, messenger, and/or photo application(s) or action(s) in an emergency situation or during a short term event (e.g., snapping a quick photo of a passing celebrity or car). Such exemplary scenarios require repeated user authentication to unlock the computing device and resume use of the application(s) or action(s).

Unfortunately, unlocking the mobile device and then executing the desired action is a multi-step process and can be cumbersome and obviously, time consuming. That is, the process of cancelling the touch lock state is somewhat complicated such that it may not be simply canceled in response to an unexpected need to access an application or take an action using the mobile device.

Given the foregoing, what are needed are systems, methods and computer program products for providing access to an application or action directly from a lock screen user interface while interacting with a computing system.

### SUMMARY

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

The present disclosure meets the above-identified needs by providing systems, methods and computer program products for providing access to an application or action directly from a lock screen user interface while interacting with a computing system.

In an embodiment, the present disclosure provides systems, methods and computer program products that facilitate accessibility to an application or action directly from a lock screen user interface while interacting with a computing system using a multi-stage approach—a first user input-based component (e.g., touch, swipe, voice commands, etc.) within a security user interface (e.g., lock screen user interface) followed by a second application or action-based component (e.g., action shortcut and/or action) launched directly from the security user interface. That is, to deactivate the lock screen user interface, the user provides an authorized user input at the computing device. Second, to access the application or action, an application or action shortcut user interface is automatically displayed, or the application or action is automatically launched—both directly from the lock screen user interface. Thus, if the authorized user input is identified as a first user input, the application or action is automatically launched. If the authorized user input is identified as a second user input, the application or action shortcut user interface is displayed and a third user input launches the application or action associated with the displayed application or action shortcut user interface.

In an embodiment, unlike conventional lock screen deactivation techniques, the approach of the present disclosure employs user input-based constraints to determine whether an application or action is launched, or whether an application or action shortcut user interface is displayed directly from a lock screen user interface. The present disclosure provides the ability to deactivate the locked state of the computing device and quickly access the application or action of an operating system (e.g., mobile computing device's operating system) or application from the operating system or application's security user interface (e.g., lock screen).

In yet another embodiment of the present disclosure, the user can predefine which application(s) or action(s) are available via shortcuts at the lock screen user interface.

In yet another embodiment of the present disclosure, application or action shortcuts displayed on the lock screen user interface are based upon user behavior or sensor data collected at the computing device (e.g., real-time location to indicate whether the owner is at home or on the road).

In yet another embodiment, the systems, methods and computer program products of the present disclosure recognize unique user input(s) (e.g., different swipe patterns or pin codes) for different shortcuts (e.g., different productivity applications/actions).

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the detailed description set forth below when taken in conjunction with the drawings in which like reference numbers indicate identical or functionally similar elements.

FIG. 1 is a block diagram of an exemplary computer system useful for implementing the present disclosure.

FIGS. 2A-B are screenshots illustrating exemplary graphical user interface (GUI) windows employing a process for providing access to an application or action (or associated shortcut user interface) directly from a lock screen user interface, according to an embodiment of the present disclosure.

FIG. 3 is a flowchart illustrating an exemplary process for providing access to an application or action directly from a lock screen user interface, according to an embodiment of the present disclosure.

FIGS. 4A-5B are screenshots illustrating exemplary GUI windows employing a process for providing access to an application or action directly from a lock screen user interface, according to alternate embodiments of the present disclosure.

### DETAILED DESCRIPTION

The present disclosure is directed to systems, methods and computer program products for providing access to an application or action directly from a lock screen user interface. (It is noted that the terms “action” and “application” may be interchangeably used throughout the present disclosure.)

In various embodiments, such systems, methods and computer program products provide a user input recognition approach that combines desirable aspects of security user interfaces and application or action accessibility in order to create an interaction that is both reliable and intuitive for users of a computing system. In a first lock screen deactivation stage, an authorized user input is detected at a lock screen user interface—which, may be displayed on a region of GUI screen of a computing device. Second, in an application or action launch stage, upon detecting an authorized user input, either the application or action is automatically launched or an application or action shortcut user interface is displayed on the GUI screen of the computing device. That is, a single authorized user input may deactivate the lock screen user interface as well as activate an application or action (or its associated shortcut user interface). Such a process streamlines the user's ability to quickly access the application or action directly from the lock screen user interface.

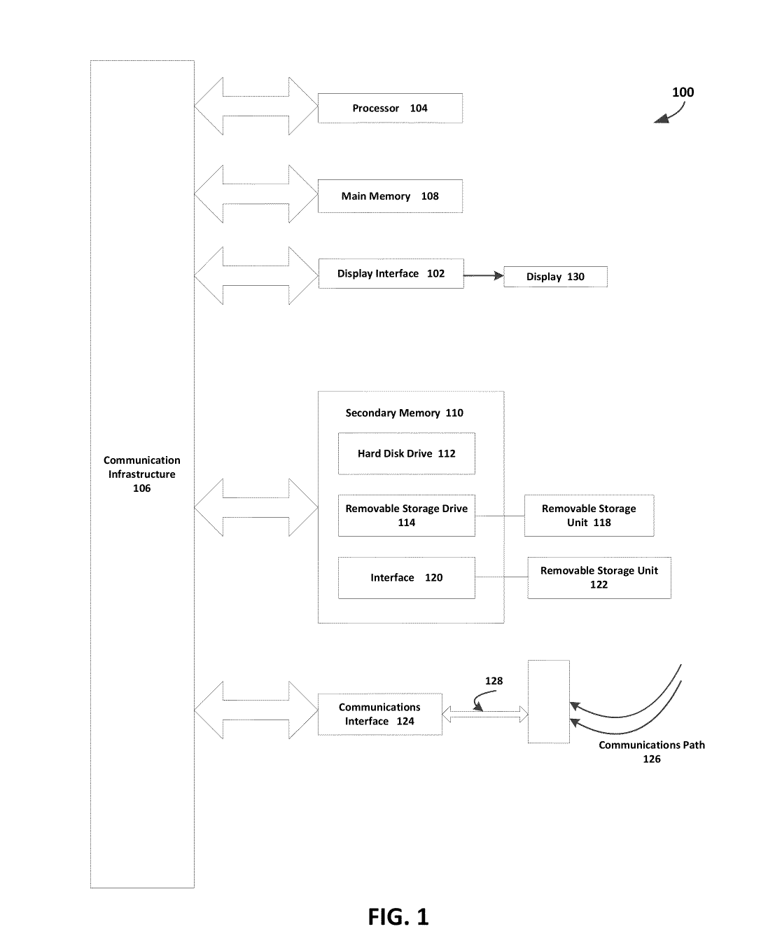

In one embodiment, the disclosure is directed toward one or more computer systems capable of carrying out the functionality described herein. An example of a computer system 100 is shown in FIG. 1.

Computer system 100 includes one or more processors, such as processor 104. The processor 104 is connected to a communication infrastructure 106 (e.g., a communications bus or network). Various software aspects are described in terms of this exemplary computer system. After reading this description, it will become apparent to a person skilled in the relevant art(s) how to implement the disclosure using other computer systems and/or architectures.

Computer system 100 can include a display interface 102 that forwards graphics, text and other data from the communication infrastructure 106 (or from a frame buffer not shown) for display on the display unit 130.

Computer system 100 also includes a main memory 108, preferably random access memory (RAM) and may also include a secondary memory 110. The secondary memory 110 may include, for example, a hard disk drive 112 and/or a removable storage drive 114, representing a floppy disk drive, a magnetic tape drive, an optical disk drive, etc. The removable storage drive 114 reads from and/or writes to a removable storage unit 118 in a well known manner. Removable storage unit 118 represents a floppy disk, magnetic tape, optical disk, etc. which is read by and written to by removable storage drive 114. As will be appreciated, the removable storage unit 118 includes a computer usable storage medium having stored therein computer software and/or data.

In alternative aspects, secondary memory 110 may include other similar devices for allowing computer programs or other code or instructions to be loaded into computer system 100. Such devices may include, for example, a removable storage unit 122 and an interface 120. Examples of such may include a program cartridge and cartridge interface (such as that found in video game devices), a removable memory chip (such as an erasable programmable read only memory (EPROM), or programmable read only memory (PROM)) and associated socket and other removable storage units 122 and interfaces 120, which allow software and data to be transferred from the removable storage unit 122 to computer system 100.

Computer system 100 may also include a communications interface 124. Communications interface 124 allows software and data to be transferred between computer system 100 and external devices. Examples of communications interface 124 may include a modem, a network interface (such as an Ethernet card), a communications port, a Personal Computer Memory Card International Association (PCMCIA) slot and card, etc. Software and data transferred via communications interface 124 are in the form of non-transitory signals 128 which may be electronic, electromagnetic, optical or other signals capable of being received by communications interface 124. These signals 128 are provided to communications interface 124 via a communications path (e.g., channel) 126. This channel 126 carries signals 128 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 114, a hard disk installed in hard disk drive 112 and signals 128. These computer program products provide software to computer system 100. The disclosure is directed to such computer program products.

Computer programs (also referred to as computer control logic) are stored in main memory 108 and/or secondary memory 110. Computer programs may also be received via communications interface 124. Such computer programs, when executed, enable the computer system 100 to perform the features of the present disclosure, as discussed herein. In particular, the computer programs, when executed, enable the processor 104 to perform the features of the present disclosure. Accordingly, such computer programs represent controllers of the computer system 100.

In an embodiment where the disclosure is implemented using software, the software may be stored in a computer program product and loaded into computer system 100 using removable storage drive 114, hard drive 112 or communications interface 124. The control logic (software), when executed by the processor 104, causes the processor 104 to perform the functions of the disclosure as described herein.

In another embodiment, the disclosure is implemented primarily in hardware using, for example, hardware components such as application specific integrated circuits (ASICs). Implementation of the hardware state machine so as to perform the functions described herein will be apparent to persons skilled in the relevant art(s).

As will be apparent to one skilled in the relevant art(s) after reading the description herein, the computer architecture shown in FIG. 1 may be configured as any number of computing devices such as a game console, a portable media player, a desktop, a laptop, a server, a tablet computer, a slate computer, a PDA, a mobile computer, a smart telephone, a mobile telephone, an intelligent communications device or the like.

In yet another embodiment, the disclosure is implemented using a combination of both hardware and software.

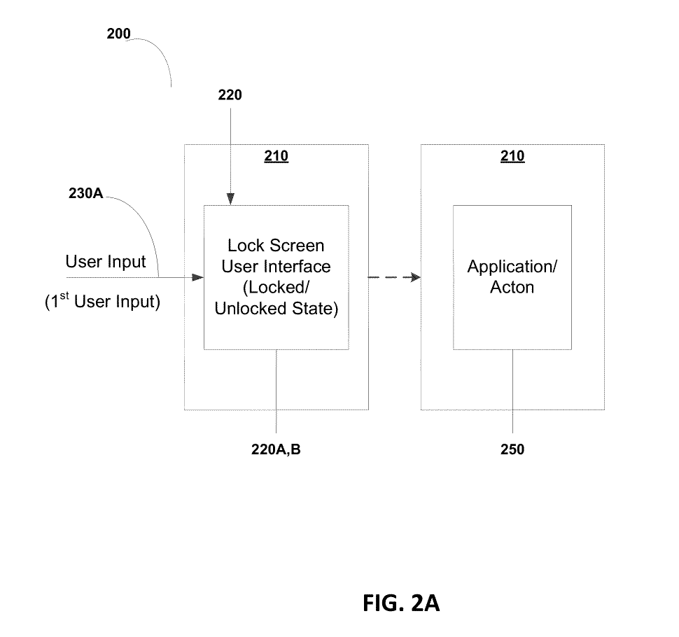

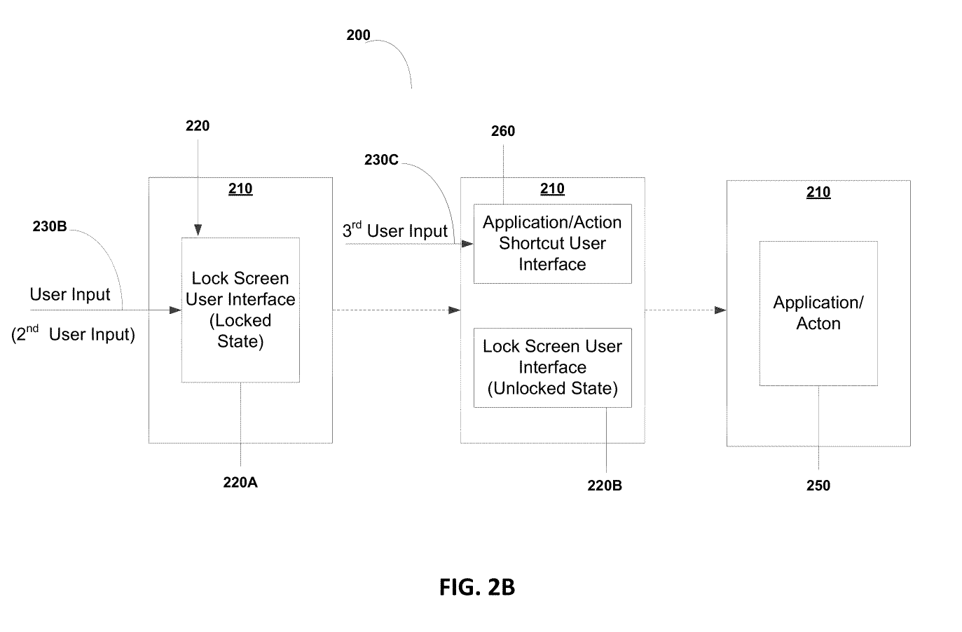

Referring to FIGS. 2A-B, block diagrams illustrating exemplary GUI environments 200 utilizing a combined lock screen deactivation and application or action access process, according to an embodiment of the present disclosure, is shown. As will be appreciated by those skilled in the relevant art(s) after reading the description herein, environment 200 would occur on computer system 100 as part of an executing computer program (software) application where swipe, touch, motion, and/or voice interaction is supported (e.g., a video game, an e-learning application, a media player application, a word processing or other productivity application, an operating system, etc.).

Environment 200 includes a GUI screen 210 produced by a computer program (software) application, executing on computing system (device) 100, where a lock screen user interface 220 is supported within GUI screen 210 of an application executing on the computing device 100 or peripheral device (e.g., in an embodiment where device 100 is a Windows® Phone, equipped with an email reader application, word processor application, text messenger application or like productivity application(s) available from Microsoft Corporation of Redmond Wash., or a laptop or tablet computer equipped with a productivity application). This allows the use of predefined user inputs authorized to unlock the computing device as well as automatically grant access to an application or action running on the computing device.

First, to begin deactivation of the lock screen user interface 220, detection of a user input 230, authorized to change the lock screen user interface 220 from a locked state 220A to an unlocked state 220B, occurs. If user input 230 is recognized as an authorized user input, lock screen user interface 220A toggles to unlocked user interface screen 220B. That is, the user is able to quickly access applications/actions 250 of a software program and/or operating system by direct input at the lock screen user interface 220. Otherwise, the lock screen user interface 220 remains at a locked state 220A. As will be appreciated by those skilled in the relevant art(s) after reading the description herein, a user at lock screen user interface 220 (or other security user interface) could provide a user input (e.g., unique gesture, unique voice command) to unlock the computing device and, while doing so, navigate directly to a desired action/application 250 or association shortcut user interface 260 (as shown in FIG. 2B). Such shortcut user interface 260 may be predefined by the operating system of the computing device and/or may be a user-defined setting.

Next, to provide access to the application or action 250 directly from the lock screen user interface 220, the user input 230 is determined to be either a first user input 230A or a second user input 230B (e.g., a predefined gesture command, voice command, etc.). If the user input 230 is the first user input 230A, an application or action 250 associated with the first user input 230A is automatically launched within GUI screen 210 of the computing device. That is, automatic launch of the action 250 indicates identification of first user input 230A, as opposed to second user input 230B.

Alternately, if the user input 230 is determined to be second user input 230B, an action shortcut user interface 260 is automatically displayed within GUI screen 210 of computing device 100. Such an action shortcut user interface 260 is associated with the second user input 230B (e.g., unique to the second user input). That is, automatic launch of the action shortcut user interface 260 indicates identification of second user input 230B.

Next, a third user input 230C may be detected at the action shortcut user interface 260. Such a third user input 230C launches the action 250 associated with the action shortcut user interface 260. That is, a list of action shortcut user interfaces 260 may be displayed within GUI screen 210 of the computing device 100. From this list, the user may select, via third user input 230C, a desired one of the action shortcut user interfaces 260 and thereby launch the associated application/action 250.

In an embodiment, after a user closes (i.e., terminates) application/action 250, lock screen user interface 220 is automatically changed from the unlocked state 220B back to the locked state 220A. That is, the user is not required to manually modify the state of lock screen user interface 220 to the locked state 220A (i.e., lock screen user interface automatically appears within GUI screen 210 of computing device 100).

As will be appreciated by those skilled in the relevant art(s) after reading the description herein, based upon detection of a deliberate and authorized user input 230, a user can both unlock the computing device 100 and navigate to a desired application or action directly from the lock screen user interface 220. Exemplary user inputs 230 can be a single user input and/or a combination of different user inputs provided at the computing device 100 (e.g., swipe/gesture/touch command at lock screen user interface 220, voice command, motion command, etc.). Authorized user inputs 230 may be detected by one or more components communicatively coupled (e.g., wired/wireless) to computing device 100 hardware, operating system and/or application or action software.

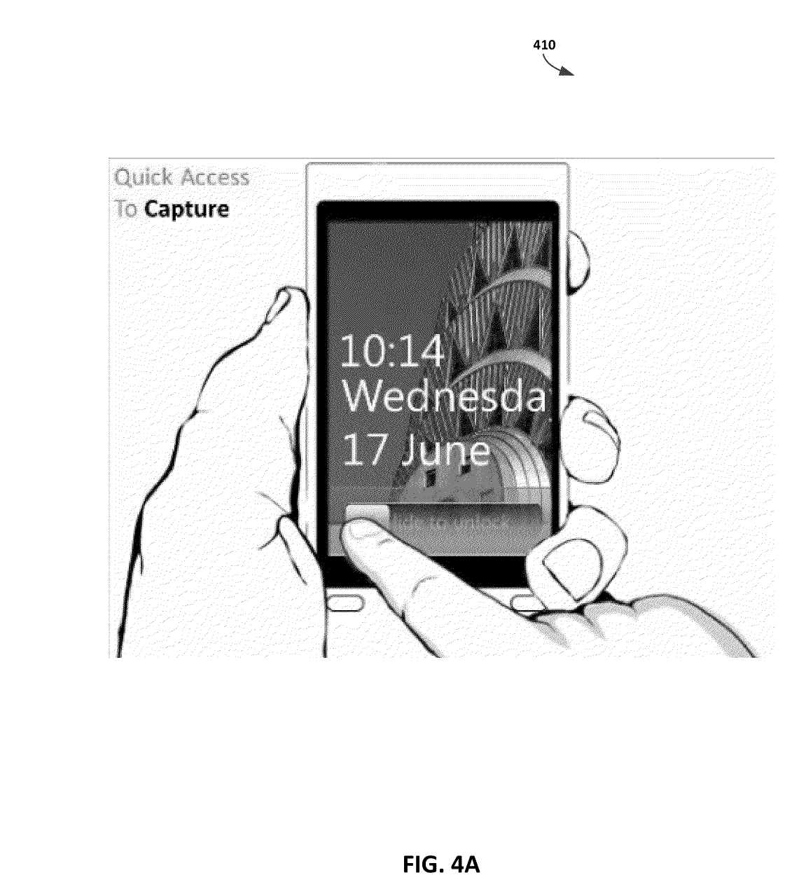

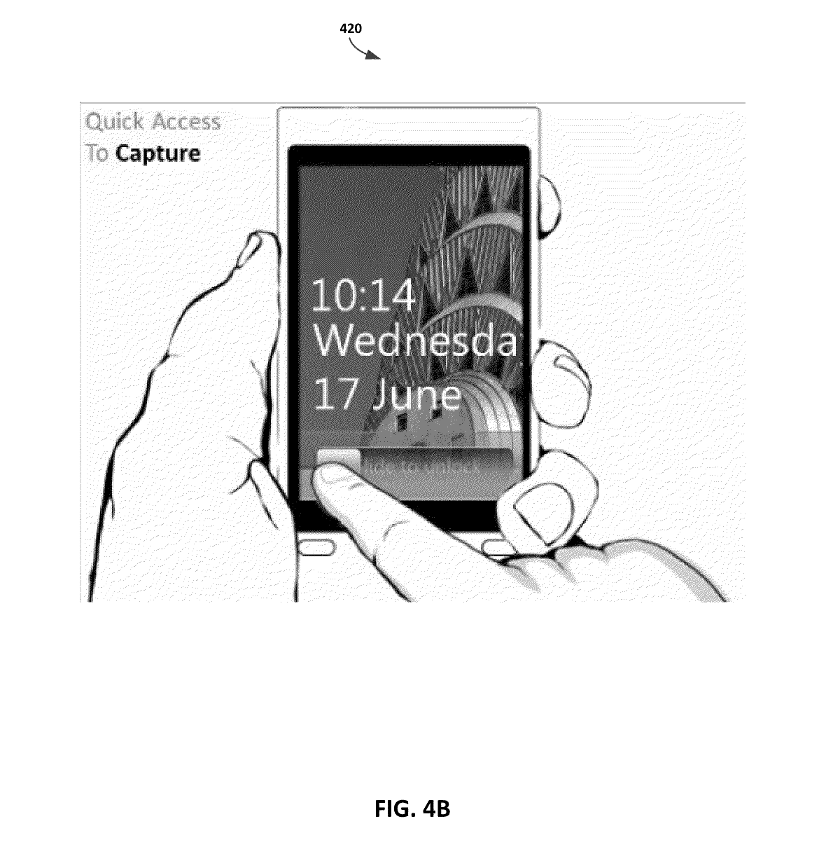

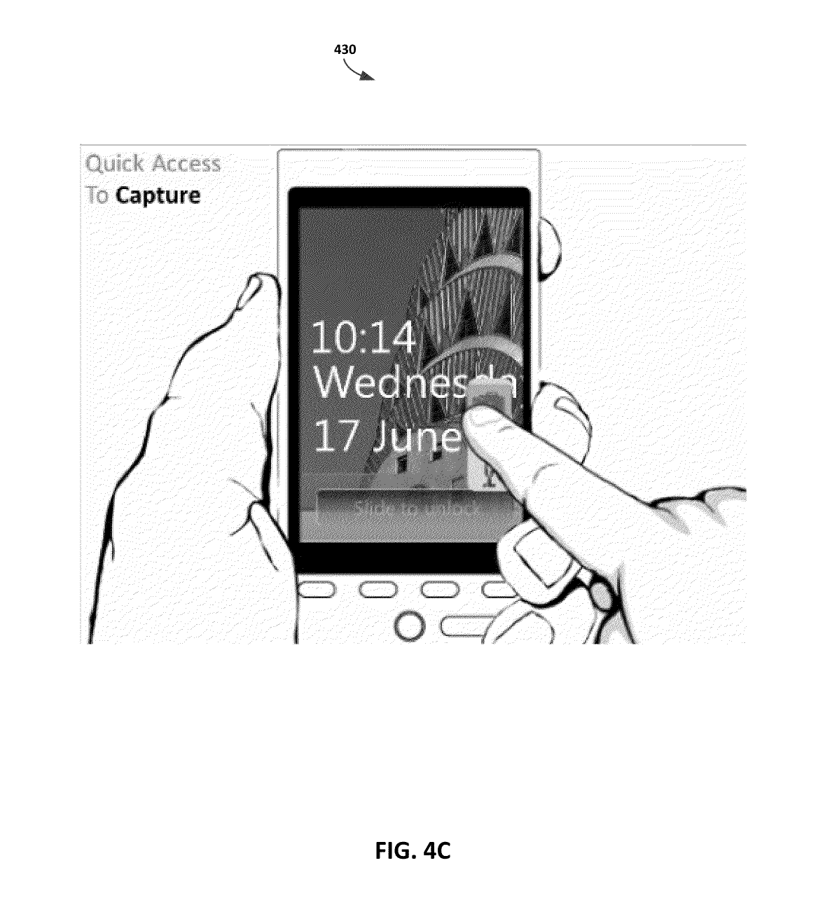

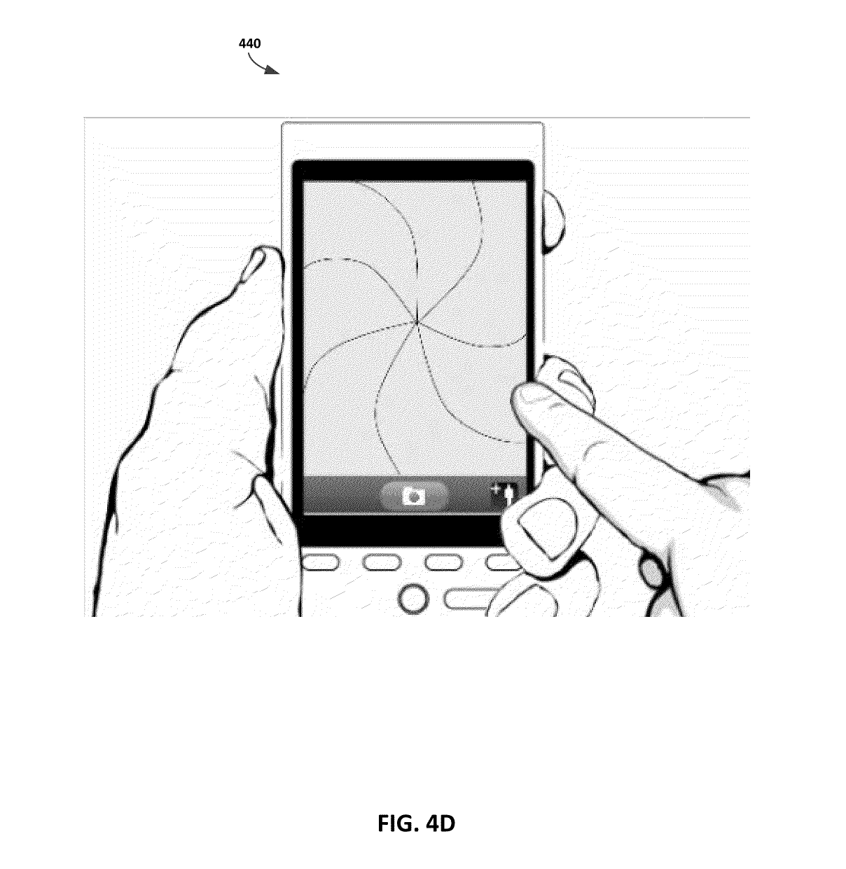

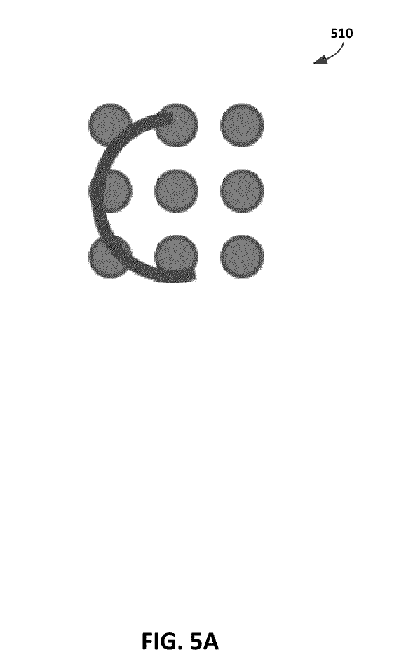

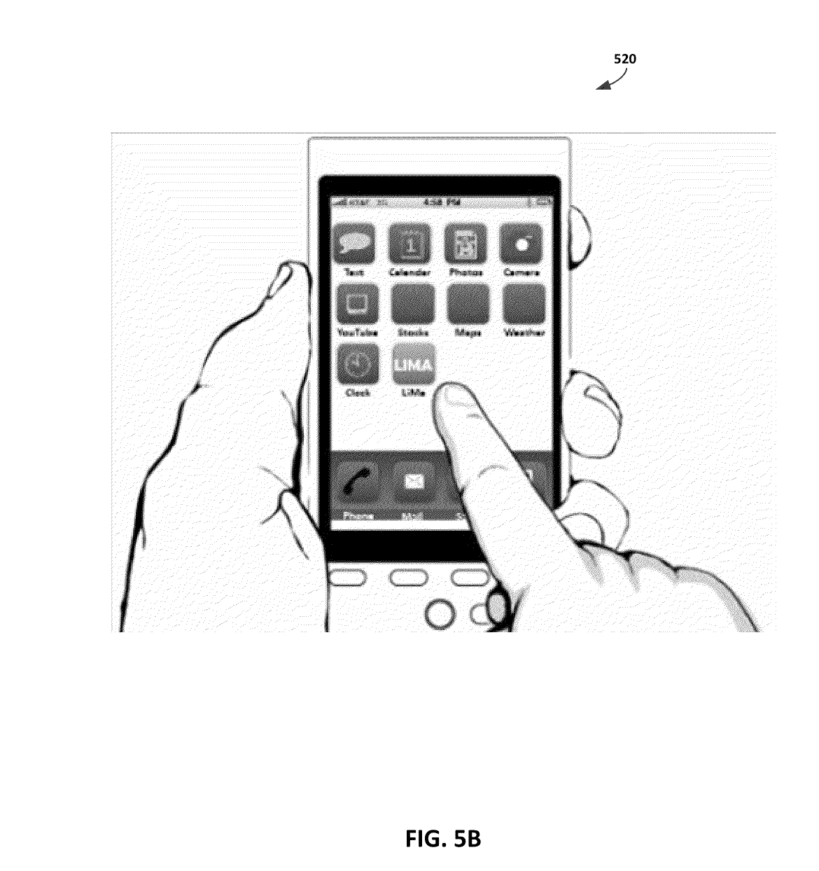

As will be appreciated by those skilled in the relevant art(s) after reading the description herein, a non-limiting exemplary component may include one more sensors such as a digitizer for detecting authorized gestures on GUI screen 210 (e.g., swipe/gesture/touch patterns; see FIGS. 4A and 5A). That is, when a preprogrammed button/command sequence is entered on GUI screen 210 of the computing device 100, an action 250 and/or action shortcut user interface 260 will automatically appear after unlocking the security user interface (e.g., lock screen user interface 220). Such preprogrammed sequences may be entered at a peripheral device (e.g., touch pad, keyboard, motion sensor, etc.) communicatively coupled to the computing device 100. As a non-limiting example, a unique unlock code (e.g., user input 230) may be associated with each application/action 250 (e.g., email reader) and/or action shortcut interface 260 (e.g., email reader shortcut). That is, swiping across several buttons of the lock screen user interface 220—such as a fluid gesture of a character or symbol (see, e.g., FIG. 5B)—may automatically display a productivity application 250 or associated shortcut user interface 260.

Another non-limiting exemplary component may include a gyroscope for detecting movement of computing device 100 (e.g., user lifts a mobile device from a non-vertical state to vertical state in a blank note page). Thus, upon detecting the preprogrammed authorized user input 230, one or more action shortcut user interfaces 260 (e.g., list of camera, video, email reader shortcuts and/or the like) may be displayed immediately after displaying lock screen user interface 220. Another non-limiting exemplary component may include a compass for detecting a direction of the computing device. Another non-limiting exemplary component may include an accelerometer for detecting whether the computing device is in an unstable environment (e.g., located within a moving vehicle). In such situations, a voice activated lock screen user interface 220 may be automatically displayed within GUI screen 210 of computing device 100, thereby displaying a voice command shortcut user interface 260 for receiving a voice command rather than a swipe/gesture/touch command.

Other non-limiting exemplary sensory components may include a microphone, a light sensor and/or a global position satellite (GPS) sensor. In one embodiment, the GPS sensor may detect a user's movement and location within a geographical zone. In response, a map/directional guidance application may automatically appear directly from lock screen user interface 220 for suggesting places to eat, driving direction, etc. In another non-limiting example, if the user location is detected as a home location, frequently called people/contact/telephone shortcut user interfaces 260 may automatically appear directly from lock screen user interface 220.

As will be appreciated by those skilled in the relevant art(s) after reading the description herein, the aforementioned security user interface can be any suitable security user interface compatible with the operating system and GUI screen 210 of the computing device 100. Non-limiting exemplary security user interfaces may include lock screen user interface 220 activated/deactivated 220A, 220B via a programmable: pin code entry, swipe gesture, and/or voice command. A variety of authorized user inputs 230 may be employed as long as there is a unique authorized user input associated with unlocking lock screen user interface 220 and automatically navigating to a particular application or action 250 or associated shortcut user interface 260.

A non-limiting exemplary authorized user input 230 may include a gesture (e.g., drawing a letter “c” as shown in FIG. 5A) drawn on lock screen user interface 220 (e.g., dot/keypad) wherein the gesture shape/pattern is associated with a particular application(s)/action(s) 250 and/or associated shortcut user interface(s) 260. For example, drawing the letter “c” on the lock screen may automatically navigate the user to the built in calculator application on device 100 after the gesture is completed (i.e., one swoop unlocks the lock screen user interface 220 and provides automatic access to associated action/application(s) 250 and/or associated shortcut(s) user interface 260).

In yet another example, an authorized unique pin code entered at the lock screen user interface 220 (e.g., FIG. 5A) may automatically perform an action without initially displaying a shortcut user interface 260 for the action (e.g., 911 may call 911 directly; 1111 may unlock the computing device and navigate directly to the user's email; 2222 may unlock the computing device and navigate directly to a calendar application).

In yet another example, an authorized voice command 230 (e.g., “call home”) in combination with a non-verbal user input 230 (e.g., holding a button down on the computing device) can unlock the lock screen user interface 220 and automatically call the user's “home” telephone number.

As will be appreciated by those skilled in the relevant art(s) after reading the description herein, various applications or actions 250 and/or associated shortcut user interfaces 260 may be automatically launched after the lock screen user interface 220A is unlocked 220B. For example, non-limiting exemplary application or action shortcut user interfaces 260 may be defined by the operating system of the computing device 100 based upon: default settings; user input; user location (e.g., home vs. work) and/or user behavior (e.g., most recently called or most frequently called people).

In another example, application or action shortcut user interfaces 260 may be defined by the user explicitly through settings in the operating system and/or application or action (e.g., a user may define which action(s) are displayed above the lock screen user interface 220). Such a user defined hierarchy of applications/actions 250 and/or associated shortcut user interfaces 260 may be used to enable a customization level (child vs. parent) of quick access on the computing device 100 (e.g., camera (parent access), telephone (child/parent access), SMS (child/parent access), GPS (child access, etc.). Quick child/parent access to application or actions 250 may also include access to the following: local search applications (e.g., the BING® Internet search engine), emergency applications (e.g., hospital, fire station, police, etc.), and messaging applications (e.g., FACEBOOK®, TWITTER®, group SMS, etc.)

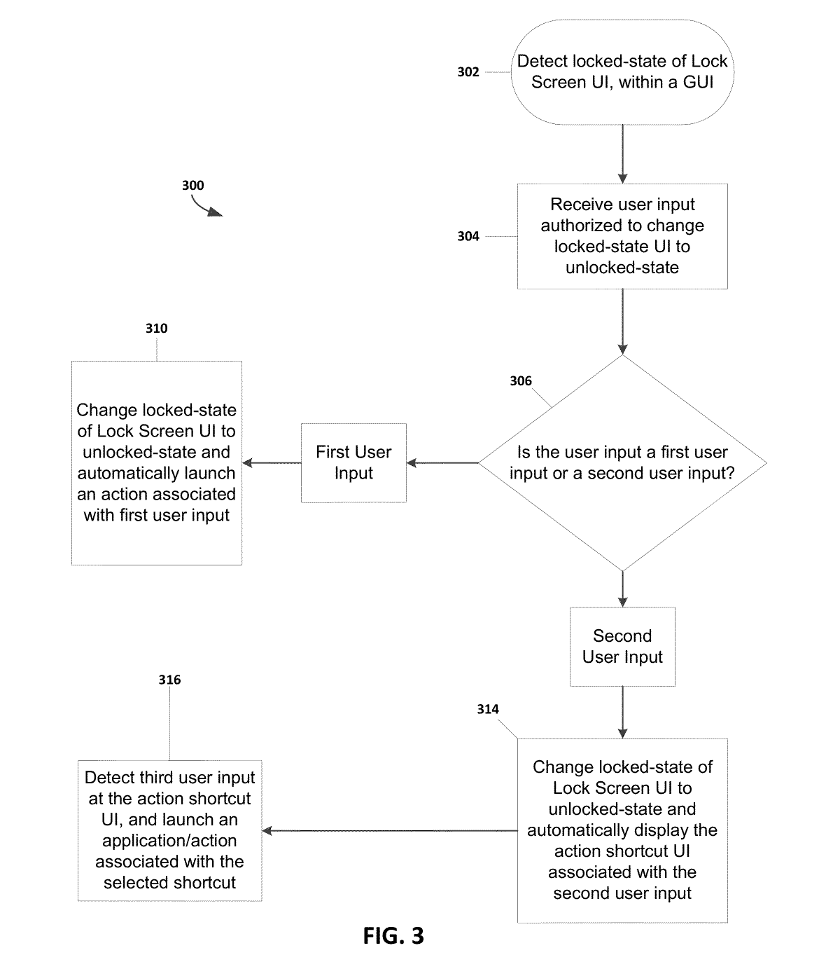

Referring now to FIG. 3, a flowchart illustrating an exemplary process 300 for providing access to an application or action directly from a lock screen user interface 220, according to an embodiment of the present disclosure, is shown.

Process 300, which would execute on computer system 100 within environment 200, begins at step 302 while GUI screen 210 is at a neutral (locked) state. Next, a lock screen user interface 220 is detected at a locked state 220A, within GUI screen 210 of an application executing on computing device 100. A visual cue may confirm the locked state of the computing device 100. For example, a pin code screen or voice command screen may prompt a user for an authorized user input 230. (e.g., FIGS. 4A and 5A.) Control would then pass to step 304.

In step 304, a user input 230 authorized to change the lock screen user interface 220 from the locked state 220A to the unlocked state 220B is received within computing device 100 (e.g., gesture, swipe, touch, voice input, etc.).

In step 306, a type of user input 230 is determined. If the determination at step 306 identifies the user input 230 as a first user input 230A, step 310 changes the lock screen user interface 220 from the locked state 220A to the unlocked state 220B, thereby automatically launching an application or action 250 (e.g., email reader, text messenger, etc.) associated with first user input 230A (e.g., creating a “c” shaped pattern on lock screen user interface 220 as shown in FIG. 5A).

If the determination at step 306 identifies the user input 230 as a second user input 230B, step 314 changes lock screen user interface 220 from locked state 220A to unlocked state 220B, thereby automatically displaying an action shortcut user interface 260 associated with the second user input 230B. That is, GUI screen 210 displays shortcut user interface 260 containing at least one shortcut to an application or action to be selected by the user. In step 316, a third user input 230C is detected at action shortcut user interface 260 and the application or action 250 associated with the selected action shortcut is then launched.

In one embodiment, in response to ending the application or action 250 (e.g., closing/terminating an application 250), an additional step may automatically change GUI 220 from an unlocked state 220B back to a locked state 220A, thereby prohibiting continued access to action 250 executing on computing device 100 (or any other applications or actions).

In an alternate embodiment, to further improve the performance of application or action accessibility process 300, action shortcut user interface 260 and lock screen user interface 220 may be simultaneously displayed on GUI screen 210 of an application executing on the computing device 100.

In an alternate embodiment, to further improve the performance of application or action accessibility process 300, action shortcut user interface 260 may be superimposed on lock screen user interface 220 and thereby visually displayed on GUI screen 210 of an application executing on computing device 100.

In yet another alternate embodiment, to further improve the performance of application or action accessibility process 300, action shortcut user interface 260 is responsive to a movement of computing device 100, the location of computing device 100, or a combination thereof. As will be appreciated by those skilled in the relevant art(s) after reading the description herein, such an embodiment may be utilized within computing device 100 that employs, for example, a sensor, GPS application and/or gyroscope.

Referring to FIGS. 4A-4D and 5A-5B, screenshots 410-440 and 510-520 illustrating exemplary GUI windows that employ application or action accessibility process 300, according to various embodiments of the present disclosure, are respectively shown. (As will be appreciated by those skilled in the relevant art(s) after reading the description herein, screenshots 410-440 and 510-520 represent different states of GUI screen 210 while process 300 executes on computing device 100.)

In an embodiment, GUI screen 210 may resemble screenshots 410-420 and 510 when lock screen user interface 220 is in a locked state 220A. GUI screen 210 may resemble screenshots 430-440 and 520 when lock screen user interface 220 is in an unlocked state 220B.

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A method for providing access to an application from a lock screen user interface, the method executing on at least one processor of a computing device, comprising the steps of:
(a) detecting a lock screen user interface, within a graphical user interface screen of an application executing on the computing device, at a locked state;
(b) receiving, at the computing device, a user input authorized to change said lock screen user interface from said locked state to an unlocked state;
(c) determining a type of said user input;
(d) when said determining step (c) identifies said type as a first user input:
(i) changing said lock screen user interface from said locked state to an unlocked state and thereby automatically launching a first application associated with said first user input; and
(e) when said determining step (c) identifies said type as a second user input:
(i) changing said lock screen user interface from said locked state to said unlocked state and thereby automatically displaying an action shortcut user interface, associated with said second user input;
(ii) detecting a third user input at said action shortcut user interface; and
(iii) launching a second application associated with said third user input.

2. The method of claim 1, further comprising the step of:
(f) changing said lock screen user interface from said unlocked state, in response to the termination of said first or second application, back to said locked state.

3. The method of claim 1, wherein the computing device is one of: a game console; a laptop; a portable media player; a slate computer; a tablet computer; a PDA; a mobile computer; and a mobile telephone.

4. The method of claim 1, wherein each of said first user input and said second user input comprises one of: a swipe input; a gesture input; a touch input; and a voice input.

5. The method of claim 1, wherein said lock screen user interface comprises at least one of: a pin code user interface; a swipe gesture user interface; and a voice prompt user interface.

6. The method of claim 1, wherein said action shortcut user interface and said lock screen user interface are simultaneously displayed on said graphical user interface screen.

7. The method of claim 1, wherein said action shortcut user interface is superimposed on said lock screen user interface and thereby visible on said graphical user interface screen.

8. The method of claim 1, wherein said action shortcut user interface is responsive to one of: a movement of said computing device; a location of said computing device; and a combination thereof.

9. A computer program product comprising computer usable medium encoded in a computer having control logic stored therein for causing the computer to provide access to an application from a lock screen user interface, said control logic comprising:
first computer readable program code means for causing the computer to detect a lock screen user interface, within a graphical user interface screen of an application executing on the computing device, at a locked state;
second computer readable program code means for causing the computer to receive a user input authorized to change said lock screen user interface from said locked state to an unlocked state;
third computer readable program code means for causing the computer to determine a type of said user input;
fourth computer readable program code means for causing the computer to change said lock screen user interface from said locked state to an unlocked state and thereby automatically launch a first application associated with said first user input; said launch of said first application indicative that the computer has identified said type as a first user input;
fifth computer readable program code means for causing the computer to change said lock screen user interface from said locked state to said unlocked state and thereby automatically display an action shortcut user interface associated with said second user input; said display of said action shortcut user interface indicative that the computer has identified said type as a second user input;
sixth computer readable program code means for causing the computer to detect a third user input at said action shortcut user interface; and
seventh computer readable program code means for causing the computer to launch a second application associated with said third user input.

10. The computer program product of claim 9, further comprising:
eighth computer readable program code means for causing the computer to change said lock screen user interface from said unlocked state, in response to the termination of said first or second application, back to said locked state.

11. The computer program product of claim 9, wherein the computer is one of: a game console; a laptop; a portable media player; a slate computer; a tablet computer; a PDA; a mobile computer; and a mobile telephone.

12. The computer program product of claim 9, wherein each of said first user input and said second user input comprises one of: a swipe input; a gesture input; a touch input; and a voice input.

13. The computer program product of claim 9, wherein said lock screen user interface comprises at least one of: a pin code user interface; a swipe gesture user interface; and a voice prompt user interface.

14. The computer program product of claim 9, wherein said action shortcut user interface and said lock screen user interface are simultaneously displayed on said graphical user interface screen.

15. The computer program product of claim 9, wherein said action shortcut user interface is superimposed on said lock screen user interface and thereby visible on said graphical user interface screen.

16. The computer program product of claim 9, wherein said action shortcut user interface is responsive to one of: a movement of said computing device; a location of said computing device; and a combination thereof.

17. A computer system capable of providing access to an application from a lock screen user interface, comprising:
(a) means for detecting a lock screen user interface, within a graphical user interface screen of an application executing on the computer system, at a locked state;
(b) means for receiving, at the computer system, a user input authorized to change said lock screen user interface from said locked state to an unlocked state;
(c) means for determining a type of said user input;
(d) means for changing said lock screen user interface from said locked state to an unlocked state and thereby automatically launching a first application associated with said first user input; said means for changing being responsive to said determining means (c) identifying said type as a first user input; and
(e) means for changing said lock screen user interface from said locked state to said unlocked state and thereby automatically displaying an action shortcut user interface, associated with said second user input; said changing means for changing being responsive to said determining means (c) identifying said type as a second user input;
(f) means for detecting a third user input at said action shortcut user interface; and
(g) means for launching a second application associated with said third user input.

18. The system of claim 17, further comprising:
(h) means for changing said lock screen user interface from said unlocked state, in response to the termination of said first or second application, back to said locked state.

19. The system of claim 17, wherein the computer system is one of: a game console; a laptop; a portable media player; a slate computer; a tablet computer; a PDA; a mobile computer; and a mobile telephone.

20. The system of claim 17, wherein each of said first user input and said second user input comprises one of: a swipe input; a gesture input; a touch input; and a voice input.
